(19) United States
(12) Patent Application Publication
(10) Pub. No.: US 2017/0360021 A1
(43) Pub. Date: Dec. 21, 2017

(54) DEVICE FOR GRABBING BAIT

(71) Applicant: Clearwater Innovations, Inc., Duluth, MN (US)

(72) Inventor: Blair Raisanen, Waconia, MN (US)

(21) Appl. No.: 15/184,588

(22) Filed: Jun. 16, 2016

(51) Int. Cl. A01K 97/14; A01K 99/00

(52) U.S. Cl. CPC A01K 97/14; A01K 99/00

(57) ABSTRACT

Devices and methods for grabbing bait are generally disclosed. In an example, a device for grabbing bait may include a first clasp formed at a distal portion of a first arm extending from a body. The device may further include a second clasp formed at a distal portion of a second arm extending from the body. At least one of the clasps may include a barrier disposed on a first side of the at least one clasp. The clasps may be adapted to be brought together in an uneven fashion, causing bait between the clasps to be urged towards the barrier when the clasps are brought together about the bait.

### BACKGROUND

Natural bait is often used to attract and catch fish. Examples of natural bait include worms, insects, leeches, and bait fish. While natural bait presents certain advantages over artificial bait, there are also challenges to using natural bait. Natural bait, especially live natural bait, can be difficult to hold, which creates challenges when preparing a fishing hook or other apparatus with the bait.

### SUMMARY

An example device for grabbing bait may include a first clasp formed at a distal portion of a first arm extending from a body. The device may further include a second clasp formed at a distal portion of a second arm extending from the body. At least one of the clasps may include a barrier disposed on a first side of the at least one clasp. The clasps may be adapted to be brought together in an uneven fashion by hand force, causing bait between the clasps to be urged towards the barrier when the clasps are brought together about the bait.

A method for grabbing bait may include bringing a first portion of separated clasps towards each other about a bait. The method may further include urging the bait towards a first side of the clasps by bringing a second portion of the clasps towards each other about the bait. The distance between the first portion of the matched clasps may be smaller than the distance between the second portion of the matched clasps.

A device for grabbing bait may include first and second clasps adapted to be brought together, each clasp having a first side and a second side. The device may further include a barrier at the second side of at least one of the clasps. The clasps may be tilted toward each other such that the first side of the first clasp and the first side of the second clasp are closer together than the second side of the first clasp and the second side of the second clasp.

Additional advantages and novel features of the invention will be set forth in part in the description that follows, and in part will become apparent to those skilled in the art upon examination of the following, or may be learned through routine experimentation upon practice of the invention.

### BRIEF DESCRIPTION OF THE DRAWINGS

FIG. 1 illustrates a perspective view of an example device for grabbing bait.

FIG. 2 illustrates a left side view of the example device.

FIG. 3 illustrates a right side view of the example device.

FIG. 4 illustrates a front view of the example device.

FIG. 5 illustrates a back view of the example device.

FIG. 6 illustrates a top view of the example device.

FIG. 7 illustrates a bottom view of the example device.

FIG. 8 illustrates a front view of an example device with clasps partially closed.

FIG. 9 illustrates a right side view of the example device with clasps partially closed.

FIG. 10 illustrates a front view of an example device with clasps fully closed.

FIG. 11 illustrates a right side view of the example device with clasps fully closed.

FIG. 12 illustrates a front view of an example device with clasps closed about bait.

FIG. 13 illustrates a front view of an example device with clasps closed about bait.

FIG. 14 illustrates a front-right perspective view of the example device with clasps closed about bait.

### DETAILED DESCRIPTION

Devices and methods for grabbing bait are described. Devices and methods in accordance with the embodiments herein may be relevant to improving grabbing, holding, and hooking of bait than currently available devices.

According to some embodiments herein a device for grabbing bait includes clasps that come together to hold bait in place. In an example, the clasps may be configured to urge the bait in a particular direction as the clasps are brought together. In this manner, the movement may secure the bait against the barrier. For example, the clasps may be brought together in an uneven or twisting motion to move the bait in a particular direction. In an example, the particular direction may be towards a barrier near a side of the clasps. In an example, the device may define slots in the clasps, through which a hook can be applied to the bait. In an example, complimentary portions of the clasps may define a relatively sharp edge, which may facilitate picking up bait. In an example, the device may be sized and shaped to fit within a standard tackle box.

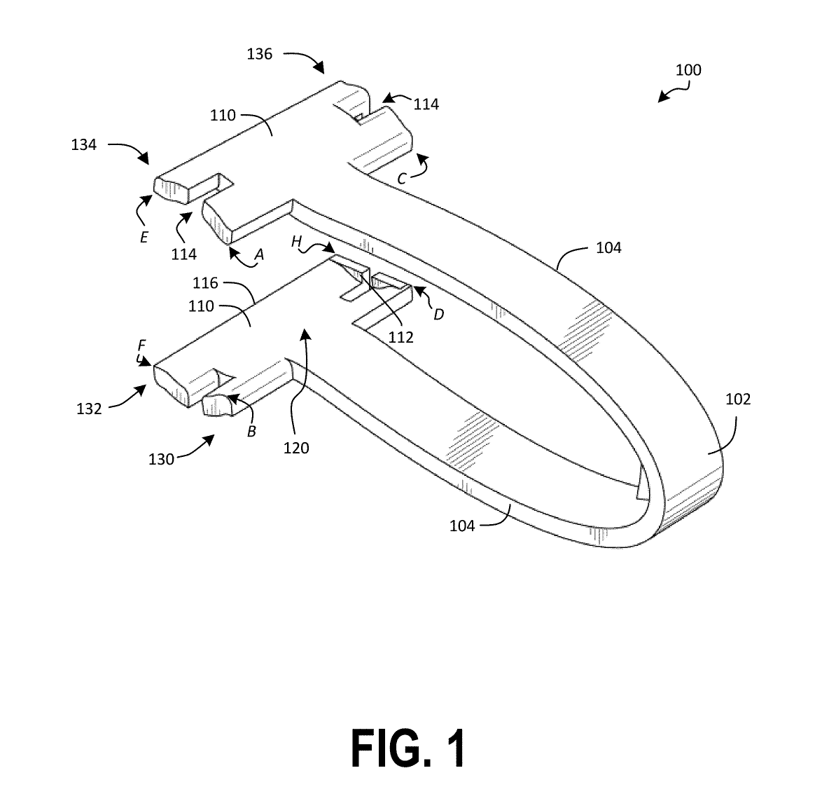

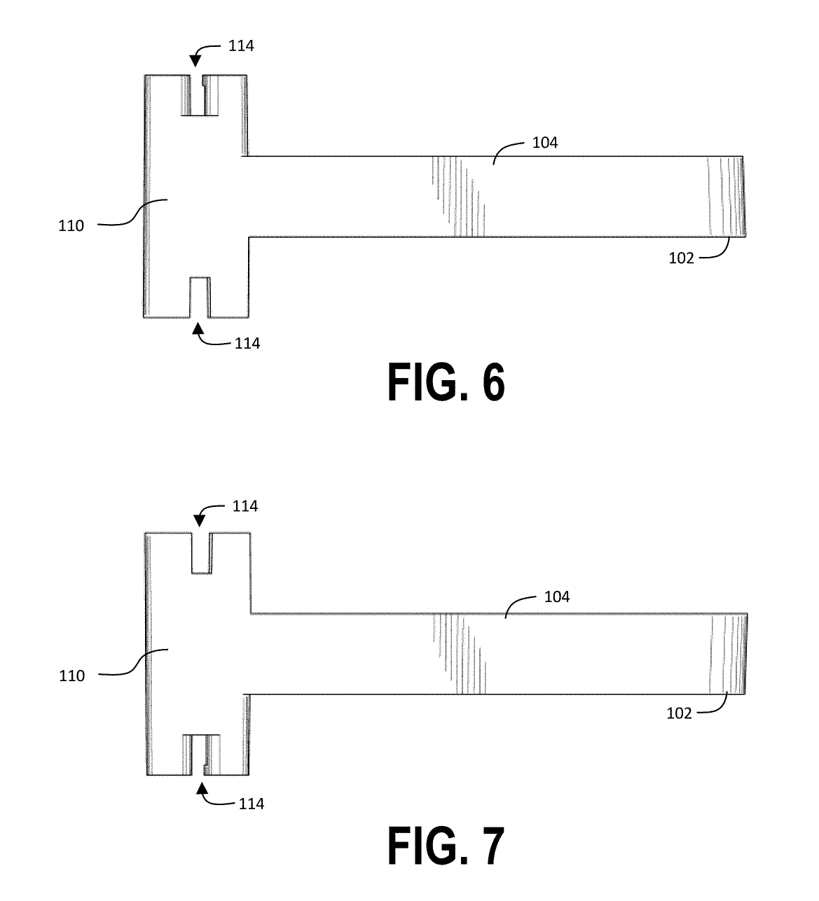

FIGS. 1-7 illustrate an example device 100 for grabbing bait, according to some embodiments. The device 100 may include a body 102 from which arms 104 extend. At the ends of the arms 104 may be clasps 110. The clasps 110 may each include a barrier 112 at an end. The clasps 110 may each define slots 114 and have an inner, front edge 116. An area between the clasps 110 may define a bait holding area 120.

For ease of reference, portions of the device 100 may be referred to as proximal (towards the body 102) and distal (away from the body 102). For example, a clasp 110 may have a proximal end 130 and a distal end 132. Further, portions of a clasp 110 may be referred to in relation to a first side 134 or a second side 136. The first side 134 may be a side of the clasp 110 without a barrier 112 and the second side 136 may be a side of the clasp 110 with the barrier 112. Portions of the device 100 may be described as points A-G. Point A may be a point near a proximal end 130 of a first side 134 of a first clasp 110. Point B may be a corresponding point on the second clasp 110. Point C may be a point near a proximal end 130 of a second side 136 of the first clasp 110. Point D may be a corresponding point on the second clasp 110. Point E may be a point on a distal end 132 on the first side 134 of the first clasp 110. Point F may be a corresponding point on the second clasp 110. Point G may be a point on a distal end 132 of the second side 136 of the first clasp 110. Point H may be a corresponding point on the second clasp 110.

In some embodiments, the body 102 may be an area between the arms 104 from which the arms 104 extend or are otherwise attached. In some embodiments, the body 102 may be deformable to allow movement of the arms 104. In some embodiments, the body 102 may have a hinged connection with the arms 104.

In some embodiments, the arms 104 may be elongate structures extending from or connected to the body 102. The arms 104 may be configured as a location where a user may hold the device 100 and apply force to cause the clasps 110 to come together (e.g., to grab and hold bait). For example, the arms 104 may be curved, bowed out, or otherwise configured to arrange the clasps 110 in a particular position and provide for an ergonomic place for the user to manipulate the device 100.

In some embodiments, the clasps 110 may be portions of the device 100 at distal ends of respective arms 104. The clasps 110 may be elongate. The clasps 110 may be oriented substantially perpendicular to the arms 104. The device 100 may be configured such that clasps 110 are complimentary and configured to be brought together to close about bait. In some embodiments, the shape and features of one clasp 110 may mirror the shapes and features of another clasp 110. For example, the clasps 110 may be mirrored, such that when the clasps 110 are brought together, the respective barriers 112 of the clasps 110 contact each other. In some embodiments, the clasps 110 may extend straight from the arms 104.

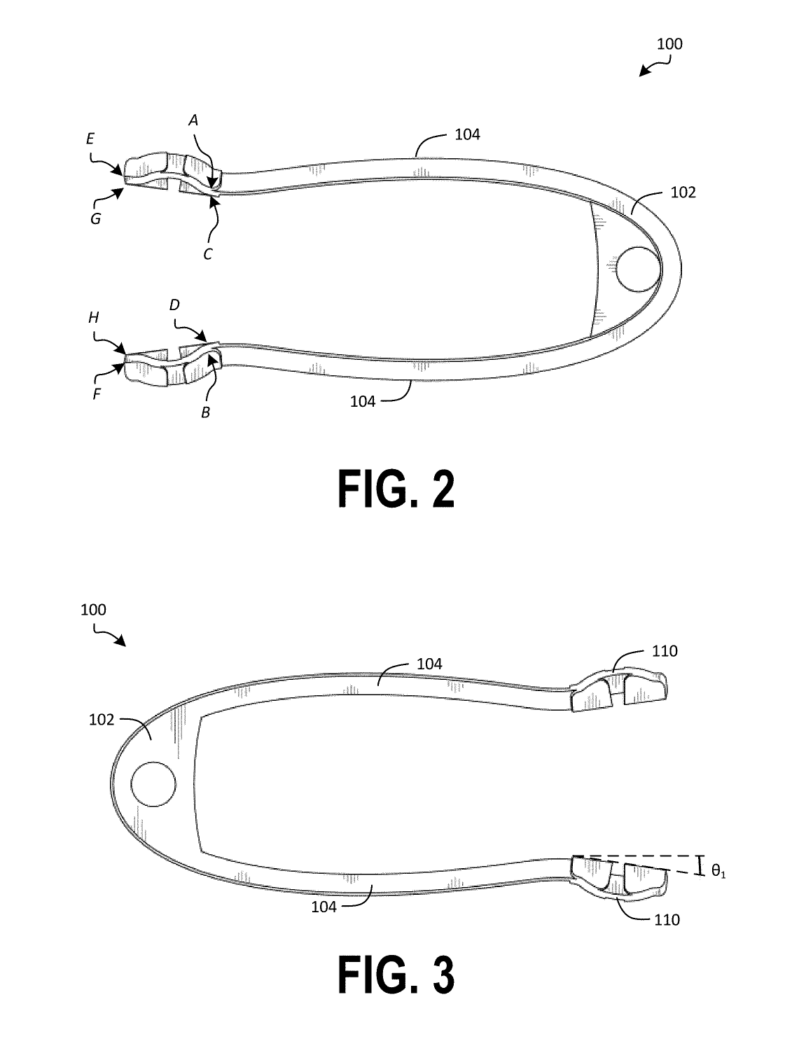

In some embodiments, the clasps 110 may be angled towards or away from each other when viewed from the top or the bottom (see, e.g., FIGS. 2 and 3). The clasps 110 may extend from the arms 104 at an angle θ₁. In some embodiments, the angle θ₁ may be less than approximately 90°, less than approximately 75°, less than approximately, 50°, less than approximately 25°, less than approximately 15°, less than approximately 10°, approximately 8°, less than approximately 5°, greater than approximately 0°, or another angle. In some embodiments, the angle θ₁ may be between approximately 0° and approximately 90°, between approximately 0° and approximately 45°, between approximately 5° and approximately 15°, between approximately 5° and approximately 10°, or be within another range. In some embodiments, the angle θ₁ of the clasps 110 may be selected or adjusted to facilitate a particular closing of the clasps 110.

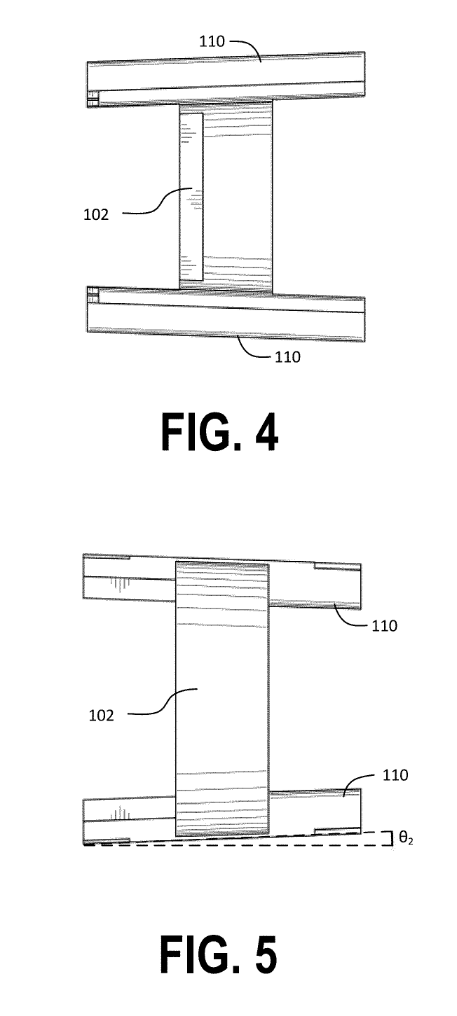

In some embodiments, the clasps 110 may be tilted towards or away from each other when viewed from the front or the back (see, e.g., FIGS. 4 and 5). The clasps 110 may be tilted towards each other at an angle θ₂. In some embodiments, the angle θ₂ may be less than approximately 90°, less than approximately 75°, less than approximately 50°, less than approximately 25°, less than approximately 15°, less than approximately 10°, less than approximately 5°, approximately 2.5°, greater than approximately 0°, or another angle. In some embodiments, the angle θ₂ may be between approximately 0° and approximately 90°, between approximately 0° and approximately 45°, between approximately 0° and approximately 15°, between approximately 1° and approximately 5°, or be within another range. In some embodiments, the angle θ₂ of the clasps 110 may be selected or adjusted to facilitate a particular closing of the clasps 110.

In some embodiments, the barrier 112 may be a raised portion of a clasp 110. The barrier 112 may extend towards an opposite clasp 110 and help define the bait holding area 120. The barrier 112 may be located along or near a side of the clasp 110 and may extend into the bait holding area 120. The barrier 112 may present a flat face towards the bait holding area 120. The barrier 112 may resist movement of bait in a particular direction. For example, the barrier 112 may resist movement of bait in a direction parallel to the clasp 110. The barrier 112 may be substantially perpendicular to the edge 116.

In some embodiments, the slots 114 may be slots defined by the clasps 110, and may be adapted to be a feature through which bait in the bait holding area 120 may be hooked or otherwise prepared for fishing. A clasp 110 may have one or more slots 114 and each slot 114 may compliment and align with a respective slot 114 on the other clasp 110.

As illustrated, the edge 116 may be an inner edge on the distal end 132 of the clasps 110. The edge 116 may be a sharp edge (e.g., as opposed to rounded). This sharp edge 116 may facilitate the grabbing and holding of bait. It may be particularly effective at grabbing several pieces of bait at once (e.g., pieces of tuna bait).

In some embodiments, the bait holding area 120 may be an area defined between the clasps 110 configured to receive and hold bait. The shape of the clasps 110 may define the shape of the bait holding area 120. The configuration of how the clasps 110 come together may also define the shape of the bait holding area 120. In an example, the clasps 110 may have a concave shape, which may define a cylindrical, conical or otherwise arcuate bait holding area 120. The arcuate bait holding area 120 may be configured to resist movement of bait in a particular direction, such as perpendicular to or parallel to the clasps 110. The bait holding area 120 may be configured to encourage movement of bait in a particular direction, such as in a direction towards the barrier 112. In some embodiments, the bait holding area 120 may be configured to resist movement of bait out of the bait holding area 120 when the clasps 110 come together. In some embodiments, the bait holding area 120 may be sized and shaped to hold particular kinds of bait.

In some embodiments, surfaces of the clasps 110 (such as surfaces facing the bait holding area 120) may be textured or otherwise have features configured to enhance holding of bait within the bait holding area 120. For example, these surfaces may be roughened, textured, and/or constructed from a material having high friction with bait. The surfaces may include points, posts, or other features configured to grip the bait.

In some embodiments, the device 100 may have a default position (e.g., when no external force is applied to the device 100) in which the clasps 110 are separated by a distance. The default position may include a default tilt and/or angle of the clasps 110. The body 102, arms 104, and/or clasps 110 may be deformable such that the clasps 110 may be brought together by application of hand force by a user. For example, a user may apply hand force to the device 100 (e.g., by squeezing or pushing the arms 104 or clasps 110), thereby causing elastic deformation of one or more components of the device 100 such that the clasps 110 come together. Upon removing the hand force, the device 100 may recover to substantially its original, default position. For example, when the user stops applying hand force to the device 100, the clasps 110 are urged apart; that is, clasps 110 spread apart.

In other embodiments, the device 100 may have a default position in which the clasps 110 are together and a user applies hand force to the device 100 to cause the clasps 110 to spread apart. For example, the device 100 may include handles, which when brought towards each other by hand force cause the clasps 110 to spread apart. When the user stops applying force to the device 100, the clasps 110 may be urged together or may come together (e.g., by spring force).

In some embodiments, the clasps 110 may be configured to close completely together, close partially together, and/or be brought together to a distance smaller than the distance in the default position. In some embodiments, substantially all of the each clasp 110 may come together at the same time. In other embodiments, particular portions of the clasps 110 may come together at different times. Closing the clasps 110 may involve the application of force (e.g., spring force or hand force) to urge the clasps 110 towards each other. Having the clasps 110 come together involves causing the clasps 110 or portions thereof to contact one another.

In some embodiments, when clasps 110 are closed, particular ends of the clasps 110 may come together before others. In an example, referring to FIG. 1, proximal ends 130 of the clasps 110 may come together before the distal ends 132 of the clasps 110, or vice versa. For instance, referring to FIG. 1, points A and B and points C and D may come together before points E and F and points G and H or vice versa.

In some embodiments, device 100 and clasps 110 are configured such that when clasps 110 are closed, particular sides of the clasps 110 may come together before others. In some embodiments, a first side 134 of the clasps 110 may come together before a second side 136 of the clasps 110, or vice versa. For example, points A and B and points E and F may come together before points C and D and points G and H, or vice versa.

In some embodiments the device 100 may be configured such that particular sides and particular ends of the clasps 110 may come together before others upon the application of hand force by a user. In some embodiments, the device 100 may be adapted such that distal ends 130 at a first side 134 of the clasps 110 may come together first, then the proximal ends 130 at the first side 136, then the distal ends 132 at the second side 134, and finally the proximal ends 132 at the second side 136. For example, the device 100 may be configured such that the points may come together in the following order upon the application of hand force: points E and F, then points A and B, then points H and G, and lastly points C and D. Other combinations of sides and points may also be used.

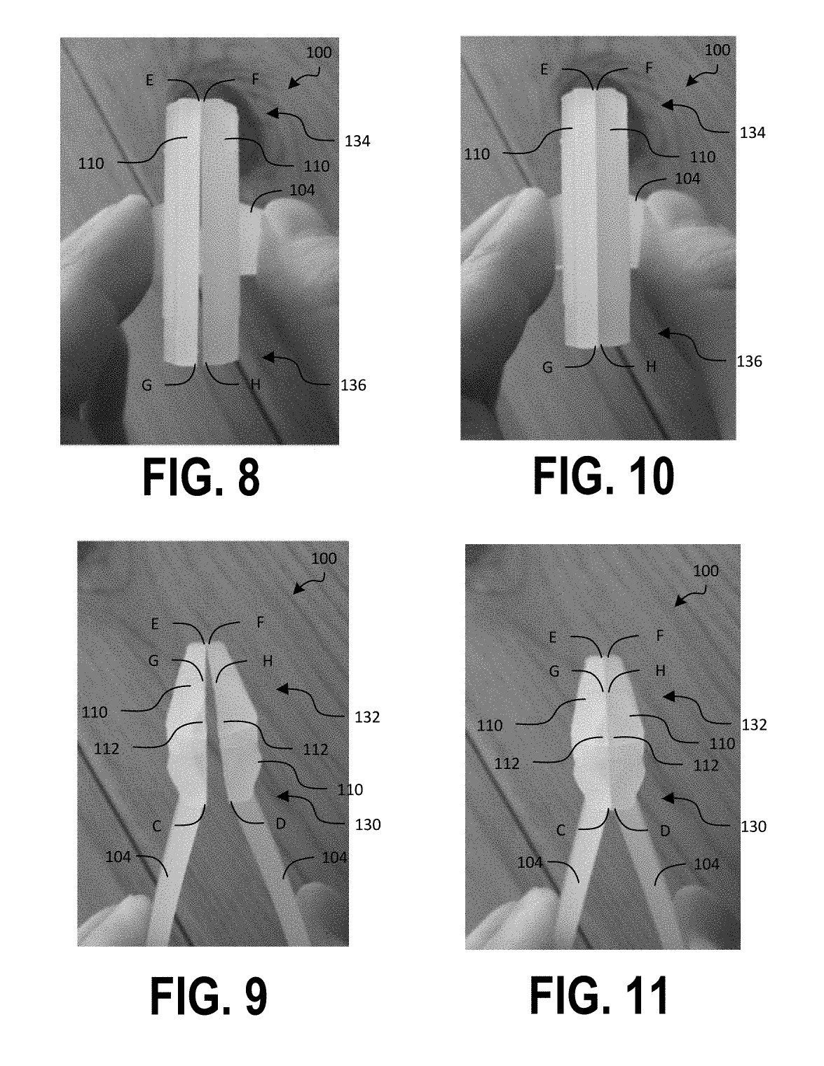

FIGS. 8 and 9 illustrate a front view and a right side view, respectively, of an example device 100 with the clasps 110 partially closed. As illustrated, a user applied hand force to the arms 104 of the device 100 until the clasps 110 partially closed. The first side 134 of the clasps 110 come together at the distal end 132 such that points E and F are in contact with each other and the other points are separated.

FIGS. 10 and 11 illustrate a front view and a right side view, respectively, of an example device with the clasps 110 completely closed. The state of the device 100 in FIGS. 10 and 11 may be reached from the state of the device in FIGS. 8 and 9 with additional hand force from the user on the arms 104 of the device 100. As a result of the hand force, the clasps have come together such that the points A-H have all come together.

In some embodiments, the device 100 may be configured to close in an uneven manner, such that closing the device 100 causes a twisting force or other force, which causes particular motion of the bait. In some embodiments, the device 100 may be configured such that the proximal ends 130 of the clasps 110 at a first side 134 come together first, then the proximal ends 130 at the second side 136, then the distal ends 132 at the first side 134, and finally the distal ends 132 at the second side 136. This uneven closing may urge a bait within the bait holding area 120 toward the second side 136. This may urge the bait against the barrier 112, which may secure the bait. When a first portion of the clasps 110 come together before a second portion of the clasps 110, continued application of force by the user to bring the second portion of the clasps 110 together may cause deformation of the device 100, which may cause the force which urges the bait against the barrier 112.

In some embodiments, the uneven closing of the clasps 110 may cause a particular portion of the bait to be against the barrier 112 and/or aligned with a slot 114 of the clasps 110. For example, the bait may be a leech and the uneven closing may cause the leech to be held such that a hook can be applied through a sucker at an end of the leech and pierce through the top of the flat side of the leech.

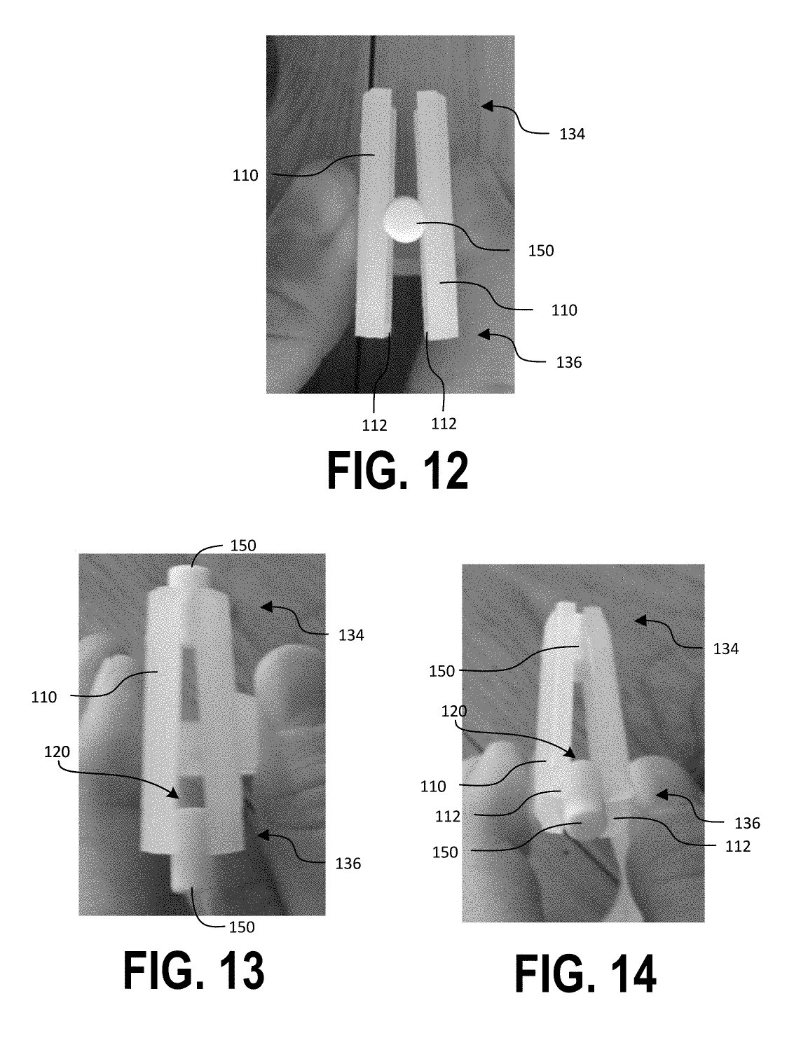

FIG. 12 illustrates a front view of an example device 100 with clasps 110 closed around bait 150. In FIG. 12, a user applied hand force to arms 104 (not visible) of the example device 100, causing the clasps 110 to close around the bait 150, which is situated in the middle of the clasps 110 in the bait holding area 120. In this configuration, the clasps 110 are closed unevenly around the bait 150, with points of a first side 134 of the clasps 110 being closer together than points of the second side 136. This uneven closing of the clasps 110 urges the bait 150 towards barriers 112 on the second side 136. While the uneven closing of the clasps 110 may urge the bait 150 in a particular direction, the bait 150 may or may not actually move in that direction and may or may not actually contact the barriers 112 in all circumstances. For example, the bait 150 may be sized, shaped, and positioned between the clasps 110 such that bait 150 does or does not contact the barrier 112. As another example, friction between the clasps 110 and the bait 150 may prevent or permit the bait 150 to slide towards the barrier 112 by the force of the uneven closing of the clasps 110. The clasps 110 having been closed unevenly about the bait 150 may continue to urge the bait 150 in a particular direction even if no new hand force is exerted.

FIGS. 13 and 14 illustrate a front view and a front-right perspective view, respectively, of an example device 100 with clasps 110 closed around bait 150 situated at the first side 134 and the second side 136 of the clasps 110. As illustrated, the second side 136 of the clasps 110 is further apart than the first side 134 of the clasps 110. The bait 150 at the second side 136 of the clasps 110 is located between the barriers 112 at the second side 136 of the clasps 110. The bait 150 is shown as being in separate pieces, but it may be viewed as representative of the clasps 110 of the example device 100 closing about a single, long piece of bait 150. The uneven closing of the clasps 110 may urge a long piece of bait 150 against the barriers 112 of the clasps 110. The urging of a long piece of bait 150 against the barriers 112 may include urging a portion of the long bait 150 against the barriers 112. For example, the clasps 110 may be closed about the long bait 150 such that a portion of the bait 150 is within the bait holding area 120, a portion of the bait 150 is pressed between the barriers 112 of the clasps 110, and another portion of the bait 150 extends past the barriers 112. The portion of the long bait 150 within the bait holding area 120 may be urged against or towards the barriers 112 by the closing of the clasps 110 about the bait 150.

In some embodiments, the device 100 may be configured to enable a user to close the clasps 110 in an uneven manner. For example, through a natural (e.g., ergonomic) application of force to the arms 104, the clasps 110 may come together in an uneven manner. In another example, the device 100 may be configured to allow a user to increase or dampen the uneven closing of the clasps 110. For instance, the user may increase or decrease the tilt and or angle of the clasps 110 as they come together. The user may cause the points to come together in a particular order by pressing on different areas of the arms 104.

In some embodiments, the device 100 may be reversible between two different configurations. In the first configuration, the clasps 110 define a first bait holding area 120, and in a second configuration, the clasps 110 define a second bait holding area 120′ (not shown). To transition from the first configuration to the second configuration, a user can bend the arms 104 of the device 100 back over the body 102. In this manner, the portions of the inside of the clasps 110 that faced the inside of the first bait holding area 120 in the first configuration now face away from the second bait holding area 120′ in the second configuration. Similarly, some portions of the clasps 110 that faced away from the first bait holding area 120 in the first configuration, may now face and define the inside of the second bait holding area 120′ in the second configuration. To facilitate defining of the different bait holding areas 120, the reversible device 100 may have double-sided clasps 110. The different sides of the clasps 110 may be configured different to better suit different kinds of bait. For example, in the first configuration, a first side of the double-sided clasps 110 define a first bait holding area 120 suitable for relatively large bait. In the second configuration, a second side of the double-sided clasps 110 define a second bait holding area 120′ suitable for relatively smaller bait.

The device 100 may be constructed in various manners from various materials. In some embodiments, the device 100 may be made from various plastics and/or various metals. The material may be selected to provide certain flexibility and deformability to the components of the device 100 to achieve one or more of the properties disclosed herein. In some embodiments, different components of the device 100 may be constructed from different kinds of materials. For example, the clasps 110 may be made constructed from a different material from the arms 104 or the body 102.

In some embodiments, one or more portions of the device 100 are made from a polymeric material having a flexural strength of about 30 MPa to 70 MPa, or about 30 MPa to 60 MPa, or about 30 MPa to 50 MPa, or about 40 MPa to 60 MPa, and a flexural modulus (stress:strain ratio in flexural deformation) of about 500 MPa to 1500 MPa, or about 500 MPa to 1250 MPa. Flexural modulus is used as an indication of a material's stiffness when flexed. Non-limiting examples of polymeric materials with suitable flexural strength and modulus for forming the device 100 include polyvinyl chloride; polyolefins such as polyethylenes, polypropylenes, and copolymers thereof; polyurethanes; polyamides; and blends of these with one or more additional materials such as polypropylene blended with a particulate filler; a nylon or polyurethane polymer blended with acrylonitrile-styrene-butadiene copolymer; polyvinyl chloride blended with a plasticizer; and the like. In one example, the device 100 is made entirely from polypropylene. In an example, the device 100 is made entirely from polypropylene homopolymer.

In some embodiments, one or more portions of the device 100 are formed from a polymeric material having a coefficient of friction with respect to itself that is at least 0.5 and as high as 2. The coefficient of friction is a dimensionless scalar value that describes the ratio of the force of friction between two bodies and the force pressing them together (i.e. “normal” force); for a given pair of device 100 surfaces, the coefficient of static friction as to between the two surfaces in some embodiments is about 0.5 to 2, or about 0.75 to 2, or about 1 to 2, or about 0.5 to 1.75, or about 0.5 to 1.5, or about 0.5 to 1.25, or about 0.5 to 1. While not limiting as to the materials useful to form the device 100 overall, use of a material having a higher coefficient of friction at least on or as part or all of clasps 110 translates to an improved ability of a user to hold bait securely within the device 100. Thus, in some embodiments a portion of device 100 is formed of a first material having a lower coefficient of friction, and one or both clasps 110 are formed of a second material having a higher coefficient of friction than the first material. In other embodiments, the device 100 is formed generally of a first material having a lower coefficient of friction and one or both clasps 110 further include a coating or a film of a second material having a higher coefficient of friction than the first material.

In some embodiments, a method of using the device 100 for grabbing bait may include providing the device 100 for use. Providing the device 100 for use may include a user removing the device 100 from a tackle box or other stored position and preparing the device 100 for use.

The method may further include providing a bait for grabbing. Providing a bait for grabbing may include removing bait from a bait storage area. Providing a bait for grabbing may further include manipulating the bait with the barrier 112 or the edge 116 of the device 100. The bait may be bait used to attract and/or catch fish including but not limited to live natural bait, dead natural bait, artificial bait, worms, insects, leeches, bait fish, and/or other kinds of bait.

The method of using the device 100 may further include placing the clasps 110 about the bait. Placing the clasps 110 about the bait may include having the clasps 110 separated by a distance and moving the bait and/or the clasps 110 such that clasps 110 are closable about the bait. For example, the clasps 110 may be closable about the bait such that the bait is within the bait holding area 120. The clasps 110 may be closable about the bait such that the bait is between the barriers 112 of the respective clasps 110.

The method of using the device 100 may further include bringing the clasps 110 towards each other about the bait. Bringing the clasps 110 towards each other about the bait may include applying force to the arms 104 and/or the clasps 110, such as by squeezing and/or pinching. Bringing the clasps 110 towards each other about the bait may include bringing the clasps 110 towards the bait in an uneven fashion. Bringing the clasps 110 towards the bait in an uneven fashion may include bringing a first portion of the clasps 110 towards each other about the bait. Bringing the clasps 110 towards the bait in an uneven fashion may include bringing a second portion of the clasps 110 towards each other about the bait. Bringing the clasps 110 towards the each other about the bait in an uneven fashion may cause the clasps 110 to urge the bait in a particular direction between the clasps 110, such as towards or away from the first or second portions. Urging the bait in a particular direction may include urging the bait towards the barrier 112 to secure the bait.

The method of using the device 100 may include applying the bait to a fishing apparatus. Applying the bait to a fishing apparatus may include attaching a hook or other fishing apparatus to the bait by inserting the hook through a slot 114 in the clasps 110. Applying the bait to a fishing apparatus may include packing the bait into a packable fishing lure.

### EXPERIMENTAL

In an experiment, an embodiment of the device 100 as shown and described with respect to FIGS. 1-7 was compared with the BAITMATE bait grabbing device by HYPARK SPECIALTY CO., INC. of Chanhassen, Minn.

When grabbing the embodiment and the BAITMATE for initial use, it was noted that if the BAITMATE was allowed to rest for about five minutes, the BAITMATE would open up to an angle too large to be easily picked up with one hand. By contrast, the embodiment was able to be easily picked up and held in one hand even after being allowed to rest.

In the experiment, both devices were used to pick up and hold a minnow. The embodiment's curved clasps prevented the bait from sliding out perpendicular to the clasps and uneven closing of the clasps forced the bait into the barrier, which prevented the bait from sliding out parallel to the clasps. The BAITMATE had curved features to stop the bait from sliding out perpendicular to its clasps and used sharp points to resist movement of the bait perpendicular to its clasps.

During the experiment, it was noted that the uneven closing of the embodiment's clasps consistently pushed bait to the end of the clasp, which presented an ideal location at which to hook certain bait, such as leeches. In particular, it is beneficial to hook a leech through its sucker and pierce through the top of the flat side of the leech. The embodiment facilitates hooking a leech in this manner.

The BAITMATE did not provide slots through which to hook the bait and the BAITMATE's large clasp size made it difficult to hook small bait in certain locations. By contrast, the embodiment's slots assisted with hooking the bait because they allowed the bait to be easily hooked perpendicularly to the clasps, which provided resistance against the bait during piercing. The embodiment's slots also made available more locations by through the bait may be hooked.

During the experiment, it was further noted that the embodiment provided advantages for picking up worms. When picking up worms using an edge of the BAITMATE device, worms would slip out unless a user dug deep and pressed tightly with the device. This process proved inconvenient. With the embodiment, a user was able to conveniently grab a worm using the barrier portion of the clasps.

Additionally each and every embodiment of the invention, as described here, is intended to be used either alone or in combination with any other embodiment described herein as well as modifications, equivalents, and alternatives thereof falling within the spirit and scope of the invention. The various embodiments described above are provided by way of illustration only and should not be construed to limit the claims attached hereto. It will be recognized that various modifications and changes may be made without following the example embodiments and applications illustrated and described herein, and without departing from the true spirit and scope of the claims.

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

1. A device for grabbing bait, the device comprising:
a first clasp formed at a distal portion of a first arm extending from a body; and
a second clasp formed at a distal portion of a second arm extending from the body,
wherein at least one of the clasps includes a barrier disposed on a barrier side of the at least one clasp; and
wherein the clasps are adapted to be brought together in an uneven fashion by hand force, causing bait between the clasps to be urged towards the barrier when the clasps are brought together about the bait.

2. The device of claim 1, wherein the first clasp includes a barrier disposed on a first side of the first clasp; and wherein the second clasp includes a barrier disposed on a first side of the second clasp.

3. The device of claim 1, wherein the first clasp and the second clasp mirror each other.

4. The device of claim 1, wherein the first clasp and the second clasp each define at least one slot adapted to receive a hook.

5. The device of claim 1, wherein at least one of the first arm, the second arm, or the body is deformable to bring the clasps together.

6. The device of claim 1, wherein the first clasp and the second clasp are angled away from each other by an angle.

7. The device of claim 6, wherein the angle is approximately 8 degrees.

8. The device of claim 1, wherein the first clasp and the second clasp are tilted toward each other by an angle.

9. The device of claim 8, wherein the angle is approximately 3 degrees.

10. A method for grabbing bait, the method comprising:
bringing a first portion of separated clasps towards each other about a bait; and
urging the bait towards a first side of the clasps by bringing a second portion of the clasps towards each other about the bait,
wherein the distance between the first portion of the matched clasps is smaller than the distance between the second portion of the matched clasps.

11. The method of claim 10, wherein bringing a first portion of the matched clasps towards each other about the bait comprises bringing the first portion of the matched clasps in contact with each other.

12. The method of claim 10, wherein the first portion is a side of the clasps opposite the first side.

13. The method of claim 10, further comprising attaching a hook to the bait by inserting the hook through a slot in the clasps.

14. The method of claim 10, further comprising manipulating the bait with a sharp edge of the device.

15. A device for grabbing bait, the device comprising:
first and second clasps adapted to be brought together, each clasp having a first side and a second side; and
a barrier at the second side of at least one of the clasps,
wherein the clasps are tilted toward each other such that the first side of the first clasp and the first side of the second clasp are closer together than the second side of the first clasp and the second side of the second clasp.

16. The device of claim 15, wherein the first clasp has a barrier at the second side of the first clasp; and the second clasp has a barrier at the second side of the second clasp.

17. The device of claim 15, wherein the first clasp and the second clasp each defines at least one slot through which a hook may be inserted.

18. The device of claim 15, wherein the first clasp is disposed at an end of a first elongate arm; wherein the second clasp is disposed at an end of a second elongate arm; and wherein the elongate arms are deformable to bring the clasps together.

19. The device of claim 18, wherein the clasps are tilted toward each other at a first angle and disposed at the end of a respective elongate arm such that the clasps are angled away from each other by a second angle.

20. The device of claim 19, wherein the first angle is greater than 0 degrees and less than 5 degrees; and wherein the second angle is greater than 0 degrees and less than 10 degrees.
